(19) United States
(12) Patent Application Publication
(10) Pub. No.: US 2024/0388809 A1
(43) Pub. Date: Nov. 21, 2024

(54) METHOD, APPARATUS, DEVICE, AND STORAGE MEDIUM FOR PANORAMIC VIDEO RECORDING

(71) Applicant: Beijing Zitiao Network Technology Co., Ltd., Beijing (CN)

(72) Inventor: Zhiyou WU, Beijing (CN)

(21) Appl. No.: 18/667,294

(22) Filed: May 17, 2024

(30) Foreign Application Priority Data
May 19, 2023 (CN) 202310573802.0

(51) Int. Cl. H04N 23/81; H04N 5/262; H04N 23/698

(52) U.S. Cl. CPC H04N 23/81; H04N 5/2624; H04N 23/698

(57) ABSTRACT

Embodiments of the present application disclose a method, an apparatus, a device, and a storage medium for panoramic video recording. The method comprises: determining a spherical projection template and an anti-distortion camera image at the current moment; determining, for each spherical coordinate point within the spherical projection template, a mapping point texture of the spherical coordinate point within the anti-distortion camera image based on a field of view of a camera; and performing pixel rendering on the spherical projection template based on the mapping point texture of each spherical coordinate point to obtain the panoramic video frame recorded at the current moment. Embodiments of the present application can eliminate camera distortion and spherical projection distortion within the panoramic video frames, achieve distortion-free recording of panoramic videos, and improve the picture quality effect of panoramic video recording.

### CROSS-REFERENCE TO RELATED APPLICATION(S)

This application claims priority to Chinese Application No. 202310573802.0 filed May 19, 2023, the disclosure of which is incorporated herein by reference in its entity.

### FIELD

Embodiments of the present application relate to a field of image processing technology, particularly to a method, an apparatus, a device, and a storage medium for panoramic video recording.

### BACKGROUND

Currently, the application scenarios of Extended Reality (XR) technology are becoming increasingly widespread, including Virtual Reality (VR), Augmented Reality (AR), Mixed Reality (MR), and the like.

Typically, a user, after wearing an XR device, may activate the Video See-Through (VST) function of the XR device to record panoramic videos of actual scenes, so that third-party users may watch the panoramic videos recorded by the user through another XR device.

In order to ensure that third-party users have an immersive viewing experience of the panoramic videos, when recording panoramic videos, each panoramic video frame may usually be projected and transformed onto a two-dimensional plane for storage through spherical projection to achieve spherical playback of the panoramic videos. However, during the projection and transformation process, the panoramic video frame may be stretched and deformed, and due to lens manufacturing processes and assembly deviations, the panoramic video frame will also have certain shooting distortion. Therefore, there is an urgent need to design a distortion-free panoramic video recording solution to eliminate various distortion phenomena in panoramic videos.

### SUMMARY

Embodiments of the present application provide a method, an apparatus, a device, and a storage medium for panoramic video recording, realizing distortion-free recording of panoramic video, reducing frame processing overhead during panoramic video recording, and improving the recording frame rate of the panoramic video on the basis of guaranteeing the picture quality effect of the panoramic video recording.

In a first aspect, embodiments of the present application provide a method for panoramic video recording. The method comprises: determining a spherical projection template and an anti-distortion camera image at the current moment; determining, for each spherical coordinate point within the spherical projection template, a mapping point texture of the spherical coordinate point within the anti-distortion camera image based on a field of view of a camera; and performing pixel rendering on the spherical projection template based on the mapping point texture of each spherical coordinate point to obtain a panoramic video frame recorded at the current moment.

In a second aspect, embodiments of the present application provide an apparatus for panoramic video recording. The apparatus comprises: an image determination module configured to determine a spherical projection template and an anti-distortion camera image at the current moment; a texture mapping module configured to determine, for each spherical coordinate point within the spherical projection template, a mapping point texture of the spherical coordinate point within the anti-distortion camera image based on a field of view of a camera; and a video frame recording module configured to perform pixel rendering on the spherical projection template based on the mapping point texture of each spherical coordinate point, to obtain the panoramic video frame recorded at the current moment.

In a third aspect, embodiments of the present application provide an electronic device. The electronic device comprises: a processor and a memory, wherein the memory is configured to store a computer program, and the processor is configured to invoke and run the computer program stored in the memory to perform the method for panoramic video recording provided in the first aspect of the present application.

In a fourth aspect, embodiments of the present application provide a computer-readable storage medium storing a computer program. The computer program causes the computer to perform the method for panoramic video recording provided in the first aspect of the present application.

In a fifth aspect, embodiments of the present application provide a computer program product, comprising computer programs/instructions, characterized in that the computer programs/instructions, when executed by a processor, implement the method for panoramic video recording provided in the first aspect of the present application.

Embodiments of the present application provide a method, an apparatus, a device, and a storage medium for panoramic video recording. By real-time recording of a panoramic video, a spherical projection template and an anti-distortion camera image at a current moment are determined first. Based on a field of view of a camera, a mapping point texture of each spherical coordinate point within the spherical projection template is determined within the anti-distortion camera image. Then, based on the mapping point texture of each spherical coordinate point, pixel rendering is performed on the spherical projection template to obtain a panoramic video frame recorded at the current moment, so as to eliminate the camera distortion and the spherical projection distortion within the panoramic video frame, to realize the distortion-free recording of the panoramic video, and to improve the picture quality effect of the panoramic video recording. Moreover, a convenient texture mapping of each spherical coordinate point to the anti-distortion camera image is realized through the field of view of the camera, without performing any three-dimensional spatial processing on the spherical coordinate points, which further reduces the frame processing overhead during the panoramic video recording, and thereby improves the recording frame rate of the panoramic video, on the basis of guaranteeing the picture quality effect of the panoramic video recording.

### BRIEF DESCRIPTION OF THE DRAWINGS

In order to explain the technical solutions in the embodiments of the present application more clearly, the drawings needed to be used in the description of the embodiments will be briefly introduced below. Obviously, the drawings in the following description are only some of the embodiments of the present application. For those of ordinary skill in the art, other drawings may also be obtained based on these drawings without exercising inventive labor.

FIG. 1 is a flow chart of a method for panoramic video recording as illustrated by an embodiment of the present application.

FIG. 2a is an exemplary schematic diagram of a spherical coordinate system in which panoramic videos are played spherically, as illustrated by an embodiment of the present application.

FIG. 2b is an exemplary schematic diagram of a two-dimensional plane in which respective panoramic video frames of a stored panoramic video after recording are projected using a spherical projection as illustrated by an embodiment of the present application.

FIG. 3 is an exemplary schematic diagram of a spherical projection template as illustrated by an embodiment of the present application.

FIG. 4 is a flow chart of another method for panoramic video recording as illustrated by an embodiment of the present application.

FIG. 5a is a schematic diagram of a principle of an imaging process of an anti-distortion camera image as illustrated by an embodiment of the present application.

FIG. 5b is a schematic diagram of a transformation relationship between a spherical coordinate (φ, θ) and a horizontal angle α_h and a vertical angle α_v, as illustrated by an embodiment of the present application, the spherical coordinate (φ, θ) is the one of any space point of the field of view within a unit spherical plane under a spherical coordinate system, and the horizontal angle α_h and the vertical angle α_v are between the space point of the field of view and the optical axis of the camera.

FIG. 6 is a method flow chart of a determination process of the mapping point texture of each spherical coordinate point within the spherical projection template provided by an embodiment of the present application.

FIGS. 7a and 7b are respectively exemplary schematic diagrams of the classification principles of the first-class spherical coordinate points and the second-class spherical coordinate points in the spherical projection template provided by embodiments of the present application.

FIG. 8 is a block diagram of an apparatus for panoramic video recording as illustrated by an embodiment of the present application.

FIG. 9 is a schematic block diagram of an electronic device as illustrated by an embodiment of the present application.

### DETAILED DESCRIPTION OF EMBODIMENTS

The technical solutions in the embodiments of the present application will be described clearly and completely in the following in conjunction with the accompanying drawings in the embodiments of the present application, and it is obvious that the described embodiments are only a part of the embodiments of the present application and not all of the embodiments. Based on the embodiments in the present application, all other embodiments obtained by a person of ordinary skill in the art without exercising inventive labor fall within the protection scope of the present application.

It should be noted that the terms “first”, “second”, etc. in the specification and claims of the present application and the above-mentioned accompanying drawings are used to distinguish between similar objects, and are not used to describe a particular order or sequence. It should be understood that the data so used are interchangeable under appropriate circumstances so that the embodiments of the present application described herein can be implemented in an order other than those illustrated or described herein. In addition, the terms “comprising” and “having”, and any variations thereof, are intended to cover non-exclusive inclusion. For example, a process, method, system, product, or server that comprises a series of steps or units is not limited to those steps or units expressly listed, but may comprise other steps or units not expressly listed or inherent to such processes, methods, products, or devices.

In the embodiments of the present application, words such as “exemplary” or “for example” are used to represent examples, illustrations or explanations. Any embodiment or solution described with “exemplary” or “for example” in the embodiments of the present application is not to be construed as being preferred or advantageous over other embodiments or solutions. Rather, use of the words “exemplary” or “for example” is intended to present relevant concepts in a specific manner.

Considering that when recording a panoramic video by means of spherical projection, the panoramic video frames will have corresponding projection distortions during the projection transformation process. Moreover, due to lens manufacturing processes and assembly deviations, the panoramic video frame will also have certain shooting distortion, resulting in various forms of distortions that may exist within the panoramic video. In order to eliminate the various distortions within the panoramic video, the present application can provide a distortion-free panoramic video recording solution. Based on the field of view of the camera, the mapping point texture of each spherical coordinate point within the spherical projection template at the current moment is determined within the anti-distortion camera image, thereby performing pixel rendering on the spherical projection template and obtaining a panoramic video frame recorded at the current moment, so as to eliminate the camera distortions and spherical projection distortions within the panoramic video frame, realize the distortion-free recording of the panoramic video, and improve the picture quality effect of the panoramic video recording.

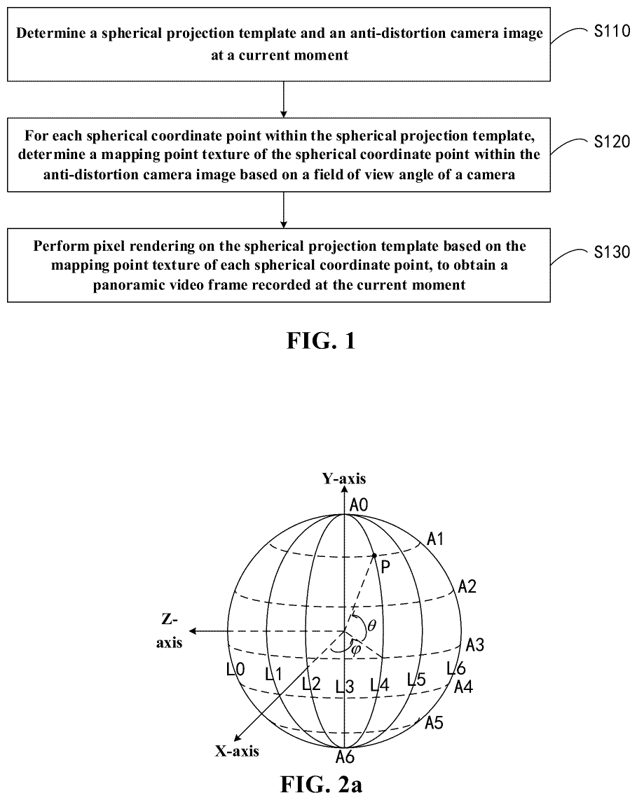

FIG. 1 is a flow chart of a method for panoramic video recording as illustrated by an embodiment of the present application. The method may be executed by the apparatus for panoramic video recording provided by the present application, wherein the apparatus for panoramic video recording may be implemented through any software and/or hardware. Exemplarily, the apparatus for panoramic video recording may be applied in any electronic device, which may include, but is not limited to, devices such as tablet computers, mobile phones (such as foldable phones, large-screen phones, etc.), wearable devices, car-mounted devices, XR devices, laptops, ultra-mobile personal computers (UMPCs), netbooks, personal digital assistants (PDAs), smart TVs, smart screens, high-definition TVs, 4K TVs, smart speakers, smart projectors, etc., and the present application does not impose any limitation on the specific type of electronic device.

Specifically, as shown in FIG. 1, the method may comprise the steps S110, S120, S130.

At S110, a spherical projection template and an anti-distortion camera image are determined at the current moment.

For any panoramic video recorded by a user, in order to ensure the playback realism of the panoramic video on other users' ends, spherical projection is typically used to record the panoramic video, to project and transform the three-dimensional real-time images within the actual scene onto a two-dimensional plane for storage, and to obtain panoramic video frames at each moment, so as to realize the spherical playback of the panoramic video.

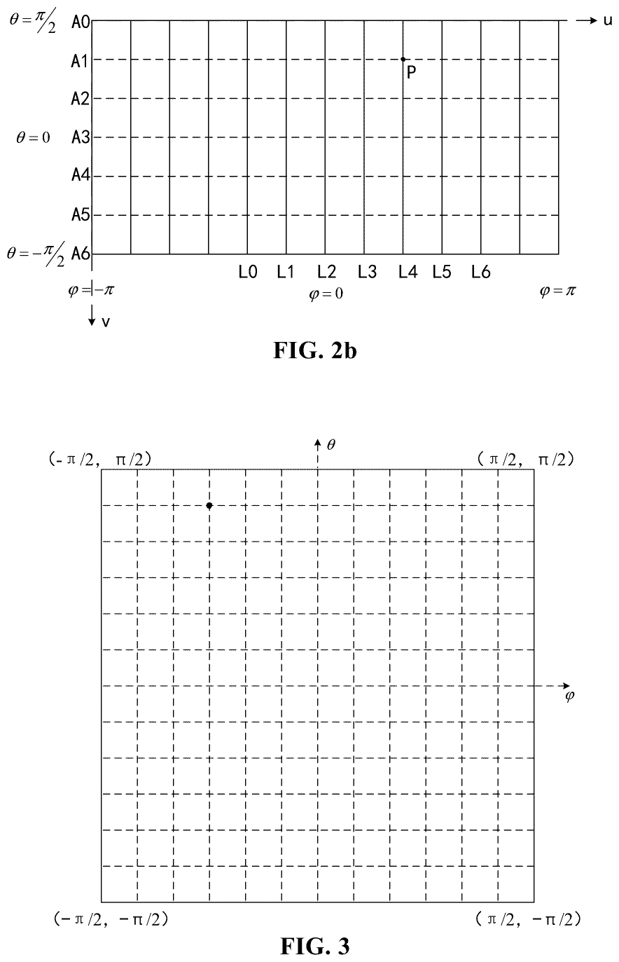

As can be seen, the respective panoramic video frames of a stored panoramic video after recording may be two-dimensional planar images projected using spherical projection. Moreover, the panoramic video is a three-dimensional video, which can be played through a corresponding sphere in the spherical coordinate system. As shown in FIG. 2a, for any spherical plane point in the spherical coordinate system (i.e., a certain pixel point in the panoramic video frame), it can be represented by an azimuth angle φ and an elevation angle θ, wherein, the azimuth angle φ may range from [−π, π], and the elevation angle θ may range from [−π/2, π/2].

Therefore, in order to ensure fast spherical presentation of the panoramic video frames, for the two-dimensional plane where each panoramic video frame is located, the present application may expand, in accordance with the azimuth angle coordinate φ and the elevation angle coordinate θ in the spherical coordinate system, the three-dimensional spherical plane into a two-dimensional plane distributed according to (φ, θ), as the two-dimensional plane where the panoramic video frames are located, as shown in FIG. 2b. Then, according to the distribution of the spherical coordinate points (φ, θ) in each panoramic video frame, the panoramic video frame may be directly rendered into the three-dimensional spherical plane in the spherical coordinate system, and the spherical presentation of the panoramic video frame can be realized.

In some implementable embodiments, the spherical projection in the present application may be an Equirectangular Projection (ERP). The ERP projection may determine a mapping relationship from any point on the three-dimensional unit spherical plane to a projection on a two-dimensional plane distributed according to (φ, θ).

In the present application, the two-dimensional plane in which each panoramic video frame in the panoramic video is located is a two-dimensional plane distributed in accordance with (φ, θ) of each spherical plane point in the spherical coordinate system. Therefore, in order to ensure the accurate recording of each panoramic video frame, the present application may preset a spherical projection template according to the viewing angle of the panoramic video frame, so as to obtain panoramic video frames at different moments by performing different texture renderings on the spherical projection template.

The rendering field of view of the spherical projection template in the present application is related to the field of view of the camera. Exemplarily, assuming that the field of view of the camera is 180 degrees, as shown in FIG. 3, the spherical projection template may be a two-dimensional plane image with rendering viewing angles, distributed according to (φ, θ), of [−π/2, π/2].

Moreover, since the rendering texture of the spherical projection template for each panoramic video frame is uncertain, each coordinate point distributed according to (φ, θ) within the spherical projection template may have a same gray value, enabling the spherical projection template to exist as a reference frame that does not contain any image information. For example, the spherical projection template in the present application may be a blank image with a gray value of 255 for each coordinate point distributed according to (φ, θ).

In order to perform corresponding texture rendering on the spherical projection template, to obtain panoramic video frames at different moments, the present application may take the camera image at each moment as the texture image of the spherical projection template at that moment, to perform corresponding texture rendering on the spherical projection template.

Moreover, during the real-time recording process of the panoramic video, an image of the surrounding environment within the actual scene may be captured by the camera in real time as the camera image in the present application. Then, the camera image at each moment will contain texture information within the panoramic video frame at that moment, so the camera image at each moment may be used as the texture image of the spherical projection template at that moment to obtain the panoramic video frame at that moment.

However, due to lens manufacturing processes and assembly deviations, the camera image captured in real time within the actual scene may have certain shooting distortion. Therefore, in order to eliminate the shooting distortion within a panoramic video frame, the present application may, during the process of real-time recording of the panoramic video, perform anti-distortion processing on the camera image at the current moment to obtain a corresponding anti-distortion camera image, so that the anti-distortion camera image is used as a texture image of the spherical projection template, at the current moment.

As an optional implementation solution in the present application, the anti-distortion camera image at the current moment may be determined in the present application by: acquiring the original camera image at the current moment; and performing anti-distortion processing on the original camera image using pre-set camera distortion parameters, to obtain the corresponding anti-distortion camera image.

In other words, in the process of real-time recording of the panoramic video, each time the original camera image at the current moment is acquired, if the original camera image is directly displayed on the screen, and when the user views the original camera image displayed on the screen through the lens mounted on the XR device, there is usually a corresponding distortion. Then, when the original camera image at each moment is used as the texture image of the spherical projection template at that moment to obtain the panoramic video frame at that moment, corresponding distortion will also exist in the panoramic video frame. Therefore, in order to eliminate the shooting distortion within the panoramic video frame, in the present application, each time the original camera image at the current moment is acquired, a corresponding anti-distortion algorithm may be used to obtain the anti-distortion camera image at the current moment by performing corresponding anti-distortion processing on the original camera image.

Exemplarily, assuming that the original camera image has not undergone anti-distortion processing, when the user views the original camera image displayed on the screen through the lens installed on the XR device, he or she will usually view the camera image under barrel distortion. Therefore, by performing anti-distortion processing on the original camera image, the camera image under pincushion distortion may be obtained as the corresponding anti-distortion camera image. Then, when the user views the anti-distortion camera image displayed on the screen through the lens installed on the XR device, he or she may view the distortion-free camera image.

At S120, for each spherical coordinate point within the spherical projection template, a mapping point texture of the spherical coordinate point within the anti-distortion camera image is determined based on a field of view of a camera.

Each pixel coordinate point in the anti-distortion camera image can represent a two-dimensional pixel point formed according to the distribution of spatial positions in the imaging plane after each space point within the field of view of the camera within the actual scene is imaged by the camera. Meanwhile, each spherical coordinate point within the spherical projection template can represent the two-dimensional pixel points formed by spherical projection of each space point within the field of view of the camera within the actual scene and distributed according to the spherical coordinates (φ, θ).

It can be seen that there is a corresponding mapping relationship between the pixel coordinate points within the anti-distortion camera image and the spherical coordinate points within the spherical projection template. And the anti-distortion camera image will contain texture information of the respective space points. Therefore, the anti-distortion camera image at each moment may be taken as the texture image of the spherical projection template at that moment, and the specific texture of each spherical coordinate point may be determined by analyzing the coordinate mapping relationship between each spherical coordinate point within the spherical projection template and the anti-distortion camera image.

By analyzing the camera imaging principle, it can be known that the pixel coordinates of different space points in the imaging plane are related to the angle between the space point and the optical axis of the camera. Moreover, the angle between the four boundary vertices of the field of view for the field of view range under the field of view of the camera and the optical axis of the camera is half of the field of view of the camera, and will be transformed into the four boundary vertices of the camera image after imaging by the camera. And the pixel coordinates of the camera image in the imaging plane take the value range of [0, 1], then the pixel coordinates of the four boundary vertices of the camera image are known. Therefore, the pixel coordinates of any pixel point within the anti-distortion camera image may be represented by the angle between the pixel point and the optical axis of the camera as well as the field of view of the camera.

Additionally, within the three-dimensional spatial coordinate system, the optical axis of the camera may be taken as the corresponding X-axis, and then by analyzing the angle between the space point corresponding to any pixel point within the anti-distortion camera image and the X-axis, the angle between the space point corresponding to that pixel point within the anti-distortion camera image and the optical axis of the camera can be determined. Moreover, the space point corresponding to any pixel point within the anti-distortion camera image is represented by spherical coordinates in the spherical coordinate system as (φ, θ), which may be mapped to the spherical coordinate point corresponding to the spherical coordinates (φ, θ) within the spherical projection template. Therefore, the spherical coordinates (φ, θ) of each spherical coordinate point within the spherical projection template may be represented by the angle between the spherical coordinate point and the X-axis (i.e., the angle between the mapping point of the spherical coordinate point within the anti-distortion camera image and the optical axis of the camera).

Consequently, based on the representation relationship between the pixel coordinates of any pixel point within the anti-distortion camera image and the angle between the pixel point and the optical axis of the camera and the field of view of the camera, as well as the representation relationship between the spherical coordinates (φ, θ) of each spherical coordinate point within the spherical projection template and the angle between the mapping point of the spherical coordinate point within the anti-distortion camera image and the optical axis of the camera, the mapping relationship between the spherical coordinates (φ, θ) of each spherical coordinate point within the spherical projection template represented by the field of view of the camera and the pixel coordinates of any pixel point within the anti-distortion camera image can be determined.

Furthermore, after determining the anti-distortion camera image and spherical projection template at the current moment, for each spherical coordinate point within the spherical projection template, based on the mapping relationship between the spherical coordinates (φ, θ) of each spherical coordinate point within the spherical projection template represented by the field of view of the camera and the pixel coordinates of any pixel in the anti-distortion camera image, the field of view of the camera used this time and the spherical coordinate value (φ, θ) of the spherical coordinate point may be used to determine the pixel coordinates of the spherical coordinate point mapped to the anti-distortion camera image, thereby determining the mapping point of the spherical coordinate point within the anti-distortion camera image. Then, by determining the real texture information of the mapping point from the anti-distortion camera image, the mapping point texture of the spherical coordinate point within the anti-distortion camera image in the present application can be obtained.

In the present application, the mapping point texture may be a pixel color value at the mapping point within the anti-distortion camera image.

At S130, pixel rendering on the spherical projection template is performed based on the mapping point texture of each spherical coordinate point, to obtain the panoramic video frame recorded at the current moment.

After determining a mapping point texture for each spherical coordinate point within the spherical projection template, the mapping point texture for each spherical coordinate point may be rendered to the corresponding spherical coordinate point within that spherical projection template, so that each spherical coordinate point within the spherical projection template can have the same texture information as the mapping point of that spherical coordinate point within the anti-distortion camera image. Further, the spherical projection template after pixel rendering is used as the panoramic video frame recorded at the current moment. Then, when the panoramic video frames at the respective moments are played spherically according to the (φ, θ) distribution, the projection distortion of the panoramic video frames during the spherical projection transformation process and the shooting distortion caused by camera shooting may be eliminated at the same time, so as to improve the picture quality effect of the panoramic video recording.

The embodiments of the present application provide a technical solution in which, by real-time recording of a panoramic video, a spherical projection template and an anti-distortion camera image at the current moment are determined first. Based on a field of view of a camera, a mapping point texture of each spherical coordinate point within the spherical projection template is determined within the anti-distortion camera image. Then, based on the mapping point texture of each spherical coordinate point, pixel rendering is performed on the spherical projection template to obtain a panoramic video frame recorded at the current moment, so as to eliminate the camera distortion and the spherical projection distortion within the panoramic video frame, to realize the distortion-free recording of the panoramic video, and to improve the picture quality effect of the panoramic video recording. Moreover, a convenient texture mapping from each spherical coordinate point to the anti-distortion camera image is realized through the field of view of the camera, without performing any three-dimensional spatial processing on the spherical coordinate points, which further reduces the frame processing overhead during the panoramic video recording, and thereby improves the recording frame rate of the panoramic video, on the basis of guaranteeing the picture quality effect of the panoramic video recording.

As an optional implementation in the present application, in order to completely eliminate various distortions during panoramic video recording, it is necessary in the present application to accurately analyze the mapping relationship between each spherical coordinate point within the sphere projection template and each pixel coordinate point within the anti-distortion camera image to determine the true texture information of each spherical coordinate point. Therefore, the present application can provide a detailed explanation of the specific mapping process from each spherical coordinate point within the sphere projection template to the anti-distortion camera image.

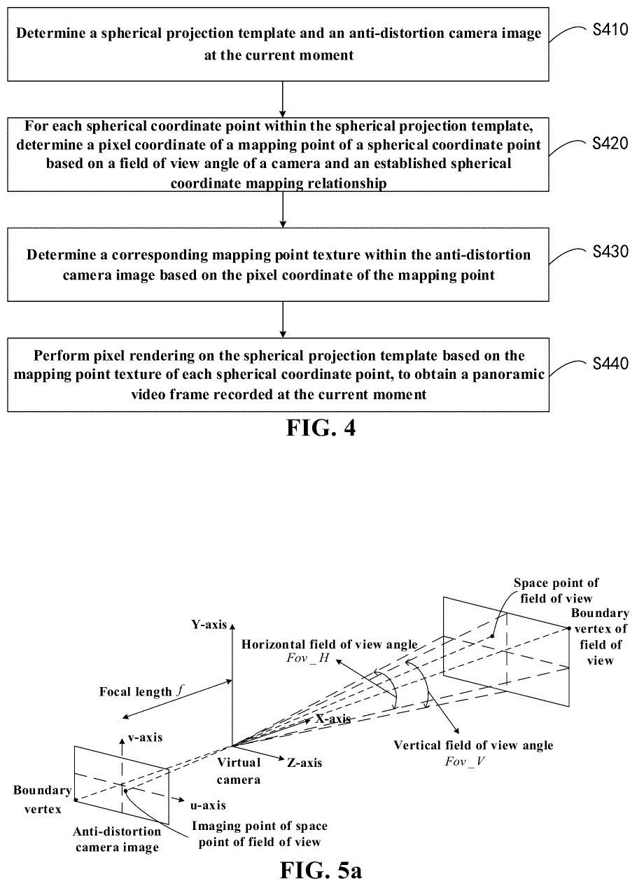

FIG. 4 is a flow chart of another method for panoramic video recording as illustrated by an embodiment of the present application. As shown in FIG. 4, the method may specifically comprise the steps S410, S420, S430, S440.

At S410, a spherical projection template and an anti-distortion camera image at the current moment is determined.

At S420, for each spherical coordinate point within the spherical projection template, a pixel coordinate of a mapping point of a spherical coordinate point is determined based on a field of view of a camera and an established spherical coordinate mapping relationship.

By analyzing the imaging process of the anti-distortion camera image, it can be known that each space point within the actual scene that is within the field of view of the camera after the camera imaging may be transformed into each pixel coordinate point within the anti-distortion camera image in accordance with the spatial position distribution in the imaging plane. Moreover, the imaging plane is perpendicular to the optical axis of the camera, and the projection point of the optical axis of the camera in the imaging plane may be the coordinate origin of the pixel coordinate system in the imaging plane.

It can be seen that the pixel coordinates of different space points in the imaging plane are related to the angle between the space point and the optical axis of the camera. Moreover, the angle between the four boundary vertices of the field of view for the field of view range represented by the field of view of the camera and the optical axis of the camera is half of the field of view of the camera, and will be transformed into the four boundary vertices within the anti-distortion camera image after imaging by the camera. And, the pixel coordinate range of the anti-distortion camera image in the imaging plane is [0, 1], so the pixel coordinates of the four boundary vertices of the anti-distortion camera image are known. Therefore, by analyzing the imaging process of any pixel point within the anti-distortion camera image, the pixel coordinate values of the pixel point within the anti-distortion camera image may be represented by using the pixel coordinates of the four boundary vertices within the anti-distortion camera image, the field of view of the camera, and the angle between the corresponding space point of the pixel point and the optical axis of the camera.

Furthermore, by analyzing the spherical projection process of the spherical projection template, it can be known that the respective space points within the field of view of the camera within the actual scene may be transformed to the respective spherical coordinate points within the spherical projection template based on the distribution of spherical coordinates (φ, θ) after the spherical projection.

Moreover, if the optical axis of the camera is taken as the corresponding X-axis within the three-dimensional spatial coordinate system, the angle between the space point corresponding to any pixel point within the anti-distortion camera image and the optical axis of the camera may be represented, by analyzing the angle between the space point corresponding to that pixel point within the anti-distortion camera image and the X-axis. Additionally, the spherical coordinates of the space point corresponding to any pixel point within the anti-distortion camera image in the spherical coordinate system are represented as (φ, θ), which may be mapped to the spherical coordinate point corresponding to the spherical coordinates (φ, θ) within the spherical projection template.

Therefore, by analyzing the relationship between the spherical coordinates (φ, θ) of each spherical coordinate point within the spherical projection template and the angle between the space point corresponding to that spherical coordinate point and the X-axis, the spherical coordinates (φ, θ) of the spherical coordinate point may be represented by using the angle between the space point corresponding to that spherical coordinate point and the X-axis.

Then, as to the computational relational equation for the pixel coordinate value of any pixel point within the anti-distortion camera image represented by the pixel coordinates of the four boundary vertices within the anti-distortion camera image, the field of view of the camera, and the angle between the space point corresponding to the pixel point and the optical axis of the camera, and the computational relational equation for the spherical coordinates (φ, θ) of each spherical coordinate point represented by the angle between the space point corresponding to that spherical coordinate point and the X-axis, in the present application, a mapping relationship between the spherical coordinates (φ, θ) of each spherical coordinate point and the pixel coordinate values of each pixel point within the anti-distortion camera image may be obtained as the spherical coordinate mapping relationship that has been established in the present application, by comprehensively analyzing the above two computational relational equations.

Further, for each spherical coordinate point in the spherical projection template, in the present application, the spherical coordinates (φ, θ) of that spherical coordinate point and the field of view of the camera used herein may be analyzed together, in accordance with the spherical coordinate mapping relationship that has been established, to determine the pixel coordinate of the mapping points of the spherical coordinate point within the anti-distortion camera image, so as to determine the mapping point of each spherical coordinate point in the anti-distortion camera image.

In some implementations of the present application, the spherical coordinate mapping relationship can be determined by the following steps.

At step one, a corresponding pixel coordinate-angle representation relationship is determined based on a first pixel coordinate of a boundary vertex of a field of view represented by the field of view of the camera in an imaging plane and a second pixel coordinate of any space point of the field of view represented by an angle between the space point of the field of view and a camera optical axis in the imaging plane.

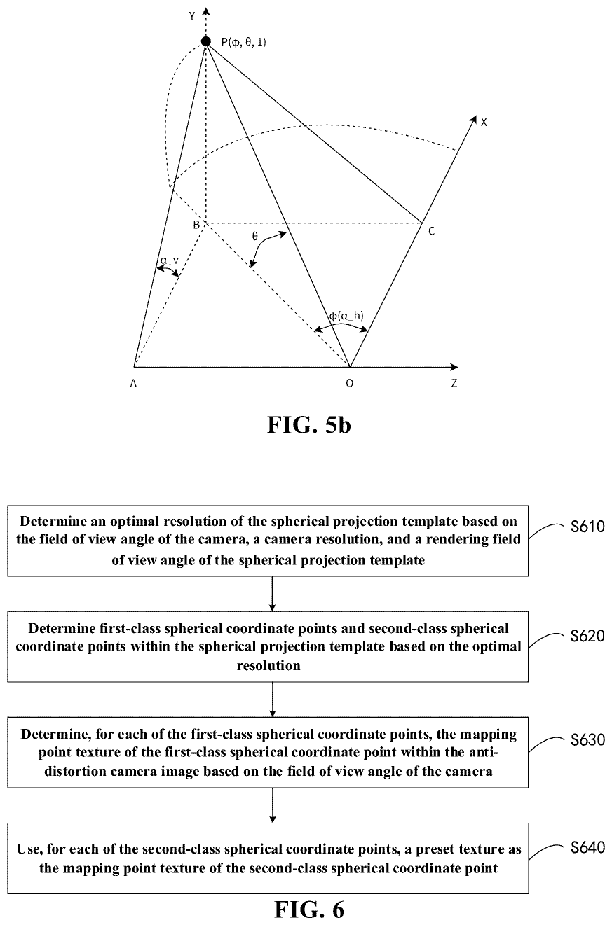

By analyzing the camera imaging process of the anti-distortion camera image, as shown in FIG. 5a, four boundary vertices of the field of view may be determined according to the camera field of view range corresponding to the field of view of the camera. Moreover, the field of view of the camera may include both a horizontal field of view and a vertical field of view. The four boundary vertices of the field of view will be transformed into four boundary vertices within the anti-distortion camera image in the imaging plane after being imaged by the camera. At the time, the optical axis of the camera is perpendicular to the imaging plane because it is the X-axis of the three-dimensional spatial coordinate system. Therefore, the projection point of the optical axis of the camera in the imaging plane may be used as the pixel origin of the pixel coordinate system in the imaging plane. Then, considering that the value range of the uv coordinates of the anti-distortion camera image after pixel normalization in the imaging plane is [0, 1], taking the lower-left corner of the imaging plane as the origin and translating the origin to the intersection point of the optical axis of the camera and the imaging plane (i.e., the center of the imaging plane), the uv coordinates of the four boundary vertices within the anti-distortion camera image may be (−0.5, −0.5), (−0.5, 0.5), (0.5, −0.5) and (0.5, 0.5) respectively.

It can be seen that since the horizontal angle between the boundary vertex of the field of view and the optical axis of the camera is half of the horizontal field of view of the camera, the vertical angle between the boundary vertex of the field of view and the optical axis of the camera is half of the vertical field of view of the camera. Therefore, the horizontal pixel coordinate value (i.e., the u value) in the first pixel coordinate of the boundary vertex of the field of view in the imaging plane may be: 0.5=tan(Fov_H/2)*f, and the vertical pixel coordinate value (i.e., the v value) in the first pixel coordinate of the boundary vertex of the field of view in the imaging plane can be: 0.5=tan(Fov_V/2)*f.

Therein, Fov_H is the horizontal field of view of the camera, Fov_V is the vertical field of view of the camera, and f is the focal length of the camera.

For any space point of the field of view within the field of view range of the camera, the horizontal and vertical angles between the space point of the field of view and the optical axis of the camera may be used in the same manner as described above to analyze the horizontal pixel coordinate value (i.e., the u value) and the vertical pixel coordinate value (i.e., the v value) in the second pixel coordinate of the space point of the field of view in the imaging plane.

Exemplarily, the horizontal pixel coordinate value (i.e., the u value) in the second pixel coordinate of any space point of the field of view in the imaging plane may be: u=tan(α_h)*f, and the vertical pixel coordinate value (i.e., the v value) in the second pixel coordinate of that space point of the field of view in the imaging plane may be: v=tan(α_v)*f.

Therein, α_h is the horizontal angle between the space point of the field of view and the optical axis of the camera, and α_v is the vertical angle between the space point of the field of view and the optical axis of the camera.

Then, by comprehensively analyzing the first pixel coordinate and the second pixel coordinate as described above, the corresponding pixel coordinate-angle representation relationship may be obtained. The pixel coordinate-angle expression relationship may represent a computational relational equation for a pixel coordinate value of any space point of the field of view within the field of view of the camera in the imaging plane (i.e., the pixel coordinate value of any pixel point in the anti-distortion camera image), which is represented by the field of view of the camera and an angle between the space point of the field of view and the optical axis of the camera.

Furthermore, the pixel coordinate-angle representation relationship may include both a horizontal pixel coordinate-angle representation relationship and a vertical pixel coordinate-angle representation relationship, where the horizontal pixel coordinate-angle representation relationship may be:

$$u = \frac{0.5 * tan ( α\_h )}{tan ( Fov\_H / 2 )} ,$$

and the vertical pixel coordinate-angle representation relationship may be:

$$v = \frac{0.5 * tan ( α\_v )}{tan ( Fov\_V / 2 )} .$$

It can be seen that if the horizontal angle α_h and the vertical angle α_v between any space point of the field of view in the field of view of the camera and the optical axis of the camera are known, the pixel coordinate value of the space point of the field of view within the anti-distortion camera image may be determined.

At step two, a corresponding spherical coordinate-angle representation relationship is determined based on a spherical coordinate of any space point of the field of view and an angle between the space point of the field of view and the optical axis of the camera.

Considering that any space point of the field of view within the field of view of the camera may be transformed into a certain spherical coordinate point within the spherical projection template by spherical projection, any spherical coordinate point within the spherical projection template may be transformed into a certain space point of the field of view on any rendering spherical plane in the spherical coordinate system based on the spherical coordinates (φ, θ).

Taking the rendering spherical plane as a unit spherical plane as an example, for the spherical coordinates (φ, θ) of any spherical coordinate point within the spherical projection template as shown in FIG. 5b, the spherical coordinate point may be transformed to a space point of the field of view P (φ, θ, 1) on the unit spherical plane in the spherical coordinate system.

At the time, as shown in FIG. 5b, the horizontal angle α_h and vertical angle α_ v between the space point of the field of view P (φ, θ, 1) and the X-axis (i.e., the optical axis of the camera) can be represented. As a result, it can be obtained that there is a corresponding transformation relationship between the spherical coordinates of the space point of the field of view (φ, θ) and the horizontal angle α_h and vertical angle α_v between this space point of the field of view and the optical axis of the camera.

During the process of camera imaging, the optical axis of the camera coincides with the X-axis and their positive directions are the same, and the angle between the pixel point located on the left side of the optical axis of the camera and the optical axis of the camera in the imaging plane is negative, while the angle between the pixel point located on the left side of the optical axis of the camera and the optical axis of the camera is positive. It can be seen that the azimuth angle coordinate φ in the spherical coordinates (φ, θ) of any spherical coordinate point within the spherical projection template has the same value as the horizontal angle α_h between the space point of the field of view corresponding to the spherical coordinate point and the optical axis of the camera, but has the opposite sign. That is, for the spherical coordinates (φ, θ) of any spherical coordinate point within the spherical projection template, α_h=−φ can be determined.

Moreover, for the elevation angle coordinate 0 in the spherical coordinates (φ, θ) of any spherical coordinate point within the spherical projection template, as shown in FIG. 5b,

$$tan ( α\_v ) = \frac{P B}{A B} ,$$

PB=sinθ, and AB=cosθ*cosφ, can be obtained. Further, in accordance with the above relationship,

$$α\_v = arctan ( \frac{tan θ}{cos φ} )$$

can be determined.

Therefore, the spherical coordinate-angle representation relationship can be determined as α_h=−φ and

$$α\_v = arctan ( \frac{tan θ}{cos φ} )$$

based on the above.

At step three, a corresponding spherical coordinate mapping relationship is determined based on the pixel coordinate-angle representation relationship and the spherical coordinate-angle representation relationship.

By comprehensively analyzing the pixel coordinate-angle representation relationship and the spherical coordinate-angle representation relationship to remove the horizontal angle α_h and vertical angle α_v between the unknown space point of the field of views and the optical axis of the camera from the pixel coordinate-angle representation relationship and the spherical coordinate-angle representation relationship, a spherical coordinate mapping relationship from any spherical coordinate point within the spherical projection template to the anti-distortion camera image can be obtained.

In the present application, from the above analysis, it can be known that the spherical coordinate mapping relationship may include spherical coordinate horizontal mapping relational equations and spherical coordinate vertical mapping relational equations. Therein, the spherical coordinate horizontal mapping relational equation may be

$$u = \frac{0.5 * tan ( - φ )}{tan ( Fov\_H / 2 )} ,$$

and the spherical coordinate vertical mapping relational equation may be

$$v = \frac{0.5 * tan θ}{tan ( Fov\_V / 2 ) * cos φ} .$$

Further, the above spherical coordinate mapping relationship is obtained by taking the center point of the imaging plane as the coordinate origin of the pixel coordinate system. However, in practice, the coordinate origin of the pixel coordinate system will usually be the boundary vertex at the lower left corner of the imaging plane. Therefore, for the final spherical coordinate mapping relationship, it is necessary to add the offset of the coordinate origin to the above spherical coordinate mapping relationship.

That is to say, the spherical coordinate horizontal mapping relational equation in the final spherical coordinate mapping relation may be

$$u = \frac{0.5 * tan ( - φ )}{tan ( Fov\_H / 2 )} + 0.5 ,$$

and the spherical coordinate vertical mapping relational equation may be

$$v = \frac{0.5 * tan θ}{tan ( Fov\_V / 2 ) * cos φ} + 0.5 .$$

Then, for each spherical coordinate point within the spherical projection template, the horizontal field of view Fov_H of the camera and the azimuth angle coordinate φ of the spherical coordinate point may be substituted into the final spherical coordinate horizontal mapping relational equation in accordance with the final spherical coordinate mapping relationship, and the horizontal pixel coordinate of the mapping points of the spherical coordinate point may be obtained. Furthermore, the vertical pixel coordinate of the mapping points of the spherical coordinate point may be obtained by substituting the vertical field of view Fov_V of the camera, the azimuth angle coordinate φ and the elevation angle coordinate θ of the spherical coordinate point into the final spherical coordinate vertical mapping relational equation.

In accordance with the above manner, the pixel coordinate of the mapping points of each spherical coordinate point within the spherical projection template may be determined within the anti-distortion camera image, so as to determine the mapping point of each spherical coordinate point within the anti-distortion camera image.

At S430, the corresponding mapping point texture within the anti-distortion camera image is determined based on the pixel coordinate of the mapping point.

After determining the pixel coordinate of the mapping points, within the anti-distortion camera image, of each spherical coordinate point within the spherical projection template, a corresponding mapping point texture may be determined within the anti-distortion camera image in accordance with the pixel coordinate of the mapping points of each spherical coordinate point as the real texture information of the spherical coordinate point, so as to subsequently perform texture rendering of the spherical projection template.

At S440, pixel rendering on the spherical projection template is performed based on the mapping point texture of each spherical coordinate point, to obtain the panoramic video frame recorded at the current moment.

In the technical solution provided by the embodiments of the present application, by real-time recording of a panoramic video, a spherical projection template and an anti-distortion camera image at the current moment are determined first. Based on the field of view of the camera, a mapping point texture of each spherical coordinate point within the spherical projection template is determined within the anti-distortion camera image. Then, based on the mapping point texture of each spherical coordinate point, pixel rendering is performed on the spherical projection template to obtain a panoramic video frame recorded at the current moment, so as to eliminate the camera distortion and the spherical projection distortion within the panoramic video frame, to realize the distortion-free recording of the panoramic video, and to improve the picture quality effect of the panoramic video recording. Moreover, a convenient texture mapping from each spherical coordinate point to the anti-distortion camera image is realized through the field of view of the camera without performing any three-dimensional spatial processing on the spherical coordinate points, which further reduces the frame processing overhead during the panoramic video recording, and thus improves the recording frame rate of the panoramic video, on the basis of guaranteeing the picture quality effect of the panoramic video recording.

According to one or more embodiments of the present application, in accordance with the industry norms of the spherical projection method, the rendering field of view of the spherical projection template is usually set as 180 degrees or 360 degrees, so that different users can record panoramic videos under a unified format, so as to support that a certain user is able to successfully view the panoramic videos recorded by the other users, and to realize successful sharing of the panoramic videos among different users.

However, since the maximum limit of the field of view of the camera is 180 degrees, it indicates that the maximum shooting field of view of the anti-distortion camera image can reach 180 degrees. Accordingly, the rendering field of view of the spherical projection template is usually greater than or equal to the shooting field of view of the anti-distortion camera image. Therefore, when the rendering field of view of the spherical projection template is greater than the shooting field of view of the anti-distortion camera image, only the spherical coordinate points within the field of view of the camera within the spherical projection template will have mapping points within the anti-distortion camera image, and the corresponding texture information will exist. However, for part of the spherical coordinate points outside the field of view of the camera within the spherical projection template, there are no mapping points in the anti-distortion camera image, and therefore, there is no texture information available.

It can be seen that when the rendering field of view of the spherical projection template is larger than the shooting field of view of the anti-distortion camera image, the anti-distortion camera image, as the texture image of the spherical projection template, cannot be spread over the entire spherical projection template. In other words, the spherical projection template, after texture rendering, will contain two parts: a textured region that is within the field of view of the camera and a non-textured region that is outside the field of view of the camera.

The number of pixel points within the anti-distortion camera image is determined by the camera resolution, and the rendering field of view of the spherical projection template is greater than the shooting field of view of the anti-distortion camera image. Then, if the entire spherical projection template is sampled using the camera resolution, the resolution of the textured regions within the spherical projection template that are within the field of view of the camera will be less than the camera resolution. In other words, when analyzing the mapping point textures of the respective spherical coordinate points within the field of view of the camera that are within the textured region of the spherical projection template within the anti-distortion camera image, the resolution of the anti-distortion camera image during texture sampling will be reduced, thereby causing a decrease in clarity of the spherical projection template after texture rendering.

For example, assuming that the camera resolution is 3000*3000, the field of view of the camera is 120 degrees, and the rendering field of view of the spherical projection template is 180 degrees, then if the camera resolution is used to sample the entire spherical projection template, the number of spherical coordinate points within the spherical projection template that are within the field of view of the camera is 3000*120/180=2000. In other words, the spherical projection template uses the anti-distortion camera image as a texture image, and the number of mapping points sampled within the anti-distortion camera image is 2000, making the resolution of the anti-distortion camera image at the time of texture sampling 2000, which is smaller than the camera resolution.

In order to ensure the clarity of the panoramic video recording, the present application describes in detail the specific mapping process of each spherical coordinate point within the spherical projection template to the anti-distortion camera image.

FIG. 6 is a method flow chart of a determination process of the mapping point texture of each spherical coordinate point within the spherical projection template provided by an embodiment of the present application. As shown in FIG. 6, the method may specifically comprise the steps S610, S620, S630, S640.

At S610, an optimal resolution of the spherical projection template is determined based on the field of view of the camera, a camera resolution, and a rendering field of view of the spherical projection template.

Since the rendering field of view of the spherical projection template is usually greater than the field of view of the camera, only the spherical coordinate points within the spherical projection template that are within the field of view of the camera have mapping points within the anti-distortion camera image. Therefore, in order to ensure the clarity of the panoramic video recording, it is required that the number of spherical coordinate points within the spherical projection template that are within the field of view of the camera is the same as the number of pixel points of the anti-distortion camera image sampled with the camera resolution, which means that the resolution of the textured region within the spherical projection template that is within the field of view of the camera may be the camera resolution.

Therefore, the ratio between the field of view of the camera and the rendering field of view of the spherical projection template will be equal to the ratio between the camera resolution and the resolution of the entire spherical projection template. Then, according to the above relationship, the resolution of the entire spherical projection template may be determined as the optimal resolution of the spherical projection template.

For example, assuming that the camera resolution is 3000*3000, the field of view of the camera is 120 degrees, and the rendering field of view of the spherical projection template is 180 degrees, the optimal resolution of the spherical projection template may be 3000*180/120=4500.

At S620, first-class spherical coordinate points and second-class spherical coordinate points within the spherical projection template are determined based on the optimal resolution.

After the optimal resolution of the spherical projection template is determined, the spherical projection template may be sampled with this optimal resolution to obtain the respective spherical coordinate points within the spherical projection template. At the time, the number of spherical coordinate points within the spherical projection template that are within the field of view of the camera is the same as the number of pixel points of the anti-distortion camera image after sampling with the camera resolution.

The spherical coordinate points within the spherical projection template that are within the field of view of the camera are the only ones that will have mapping points within the anti-distortion camera image, i.e., there is real texture information. Therefore, in order to improve the efficiency of determining the texture mapping between the spherical projection template and the anti-distortion camera image, in the present application, the spherical coordinate points within the spherical projection template that are within the field of view of the camera may be directly taken as the first-class spherical coordinate points, and the corresponding spherical coordinate points including the respective spherical coordinate points within the spherical projection template that are outside the field of view of the camera may be taken as the second-class spherical coordinate points.

Then, for each of the first-class spherical coordinate points, it is necessary to analyze the mapping point texture of that first-class spherical coordinate point within the anti-distortion camera image without analyzing the mapping of the second-class spherical coordinate points to the anti-distortion camera image, which significantly reduces the mapping computation overhead of the spherical projection template to the anti-distortion camera image and improves the efficiency of the panoramic video recording.

At S630, the mapping point texture of the first-class spherical coordinate points within the anti-distortion camera image is determined based on the field of view of the camera for each of the first-class spherical coordinate points.

For each of the first-class spherical coordinate points, there exists a mapping point within the anti-distortion camera image for that first-class spherical coordinate point. Therefore, based on the mapping relationship between the spherical coordinates (φ, θ) of each spherical coordinate point within the spherical projection template represented by the field of view of the camera and the pixel coordinates of any pixel point within the anti-distortion camera image, in the present application, the field of view of the camera used herein and the spherical coordinate value (φ, θ) of the first-class spherical coordinate point may be used to determine the pixel coordinates of the first-class spherical coordinate point mapped into the anti-distortion camera image, so as to determine the mapping point of the first-class spherical coordinate point within the anti-distortion camera image. Then, the real texture information of the mapping point is determined from the anti-distortion camera image, to obtain the mapping point texture of the first-class spherical coordinate point within the anti-distortion camera image in the present application.

At S640, for each of the second-class spherical coordinate points, a preset texture is used as the mapping point texture of the second-class spherical coordinate points.

Within the entire spherical projection template, it is only the texture information of the first-class spherical coordinate points that affects the realism of the recording of the panoramic video, while the texture information of the second-class spherical coordinate points does not affect the recording of the panoramic video. Therefore, in accordance with the diverse presentation needs of the panoramic video, texture information may be preset in the present application, and the preset texture may be a specific pixel color value, and the present application does not limit the preset texture.

For each of the second-class spherical coordinate points, the present application may directly assign the preset texture uniformly to each of the second-class spherical coordinate points, so as to obtain the mapping point texture of the second-class spherical coordinate points.

In the technical solution provided by the embodiments of the present application, an optimal resolution of the spherical projection template is determined based on the field of view of the camera, the camera resolution, and the rendering field of view of the spherical projection template. Then, based on this optimal resolution, first-class spherical coordinate points for which mapping points exist within the anti-distortion camera image and second-class spherical coordinate points for which no mapping point exists within the anti-distortion camera image are determined, so as to analyze the mapping point texture of the first-class spherical coordinate points within the anti-distortion camera image without having to analyze the mapping of the second-class spherical coordinate points to the anti-distortion camera image, which greatly reduces the mapping computation overhead in the panoramic video recording, and improves the high efficiency in the recording of the panoramic video. Moreover, the optimal resolution enables the number of the first-class spherical coordinate points within the spherical projection template that are within the field of view of the camera to be the same as the number of pixel points of the anti-distortion camera image after sampling with the camera resolution, so as to avoid downsampling of the anti-distortion camera image during texture sampling, and thus ensure the clarity of the panoramic video recording.

As an optional implementation solution in the present application, for the first-class spherical coordinate points and the second-class spherical coordinate points within the spherical projection template, the present application may determine them in two ways.

In way one, the spherical coordinate points within the spherical projection template is determined based on the optimal resolution of the spherical projection template. From the spherical coordinate points within the spherical projection template, the spherical coordinate points that are within the field of view of the camera are selected as the first-class spherical coordinate points. The remaining spherical coordinate points within the spherical projection template other than the first-class spherical coordinate points are selected as the second-class spherical coordinate points.

In other words, the optimal resolution of the spherical projection template is used to sample the spherical projection template, and the respective spherical coordinate points within the spherical projection template may be obtained. Then, the number of spherical coordinate points within the spherical projection template that are within the field of view of the camera is the same as the number of pixel points of the anti-distortion camera image after sampling with the camera resolution, so as to make the texture area actually occupied by the spherical projection template after texture rendering have the same resolution as that of the anti-distortion camera image, avoiding the downsampling of the anti-distortion camera image in texture sampling, and guaranteeing the clarity of the panoramic video recording.

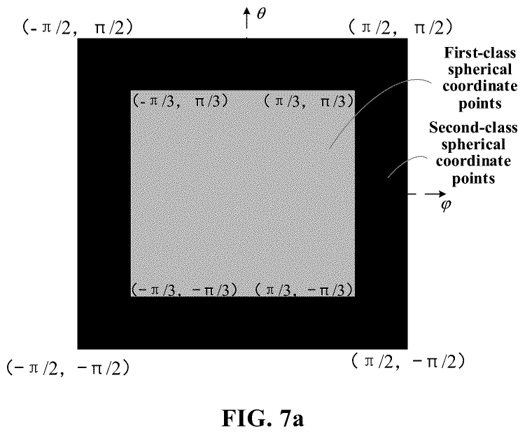

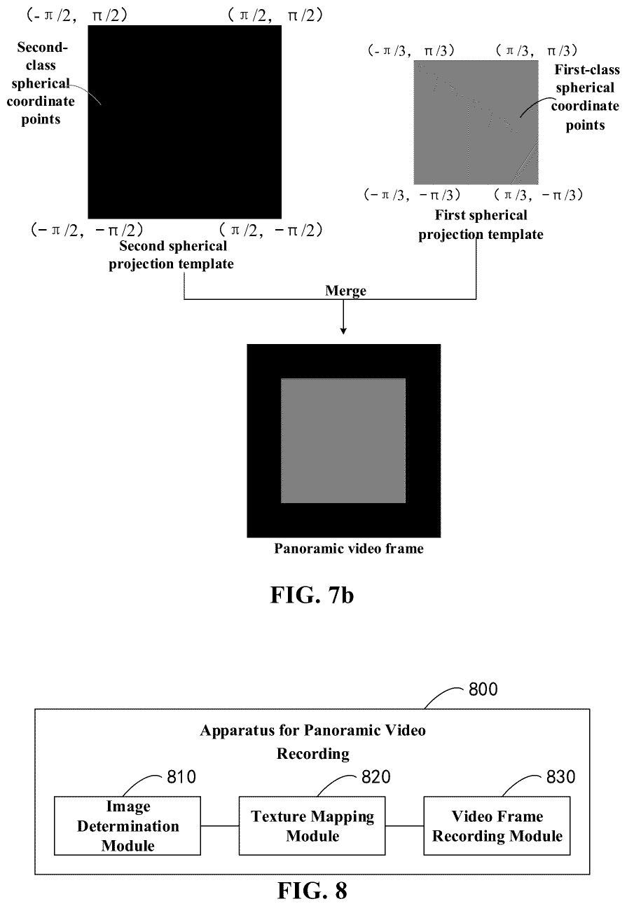

Further, as shown in FIG. 7a, in the present application, a portion of the spherical coordinate points that are within the field of view of the camera may be selected from all the spherical coordinate points within the spherical projection template as the first-class spherical coordinate points, so as to analyze the mapping of the first-class spherical coordinate points to the anti-distortion camera image. Moreover, from all the spherical coordinate points within the spherical projection template, a portion of the remaining spherical coordinate points other than the first-class spherical coordinate points, which are outside the field of view of the camera within the spherical projection template, may be determined as the second-class spherical coordinate points.

In way two, the spherical projection template is converted into a first spherical projection template and a second spherical projection template. The spherical coordinate points within the first spherical projection template is used as the first-class spherical coordinate points based on the image resolution of the first spherical projection template. The spherical coordinate points within the second spherical projection template are used as the second-class spherical coordinate points based on the image resolution of the second spherical projection template.

That is to say, after determining an optimal resolution of the spherical projection template, since this optimal resolution is different from the camera resolution, the spherical projection template may be converted into two types of spherical projection templates, i.e., the first spherical projection template and the second spherical projection template, in the present application, in order to ensure the consistency of the resolution between the spherical coordinate points within the spherical projection template and the mapping points of the anti-distortion camera image.

Therein, the rendering field of view and the image resolution of the first spherical projection template may be the field of view of the camera and the camera resolution, respectively, such that no downsampling is required for the texture mapping between the first spherical projection template and the anti-distortion camera image. Moreover, the rendering field of view and the image resolution of the second spherical projection template may be the rendering field of view and the optimal resolution of the spherical projection template, respectively, so as to comply with the recording specification of the panoramic video.

For example, assuming that the camera resolution is 3000*3000, the field of view of the camera is 120 degrees, and the rendering field of view of the spherical projection template is 180 degrees, then, the optimal resolution of the spherical projection template is 4500*4500. At the time, as shown in FIG. 7b, the spherical projection template may be converted into a first spherical projection template with a rendering field of view of 120 degrees and an image resolution of 3000*3000, and a second spherical projection template with a rendering field of view of 180 degrees and an image resolution of 4500*4500.

Then, sampling the first spherical projection template using the camera resolution allows obtaining the spherical coordinate points within the first spherical projection template as the first-class spherical coordinate points for subsequently determining the mapping point texture of the first-class spherical coordinate points within the anti-distortion camera image. Furthermore, sampling the second spherical projection template using the optimal resolution allows obtaining the spherical coordinate points within the second spherical projection template as the second-class spherical coordinate points, such that the preset texture is assigned to the second-class spherical coordinate points to obtain the mapping point texture of the second-class spherical coordinate points.

It can be understood that after converting the spherical projection template into the first spherical projection template and the second projection template, for the panoramic video frames obtained after texture rendering of the spherical projection template, the present application may determine them in the following manner: performing pixel rendering on the first spherical projection template based on the mapping point texture of each of the first-class spherical coordinate points to obtain a first panoramic candidate frame at the current moment; performing pixel rendering on the second spherical projection template based on the mapping point texture of each of the second-class spherical coordinate points to obtain a second panoramic candidate frame at the current moment; and merging the first panoramic candidate frame and the second panoramic candidate frame to obtain the panoramic video frame recorded at the current moment.

That is to say, for the first spherical projection template, the mapping point texture of each of the first-class spherical coordinate points may be rendered to the corresponding spherical coordinate points within the first spherical projection template, so that each spherical coordinate point within the first spherical projection template can have the same texture information as the mapping points of the first-class spherical coordinate points within the anti-distortion camera image, so as to obtain the first panorama candidate frame at the current moment.

Moreover, for the second spherical projection template, the mapping point texture of each of the second-class spherical coordinate points may be rendered to the corresponding spherical coordinate points within the second spherical projection template, so that each of the spherical coordinate points within the second spherical projection template can have a preset texture, so as to obtain the second panoramic candidate frame at the current moment.

Then, as shown in FIG. 7b, according to the spherical coordinate values (φ, θ) of the spherical coordinate points within the first panorama candidate frame and the second panorama candidate frame, the first panorama candidate frame tile may be merged with the second panorama candidate frame to retain the texture information of the first panorama candidate frame in the overlapping region of the two, while retaining the texture information of the second panorama candidate frame in the non-overlapping region, so as to obtain the panorama video frame recorded at the current moment.

FIG. 8 is a block diagram of an apparatus for panoramic video recording as illustrated by an embodiment of the present application. As shown in FIG. 8, the apparatus 800 may comprise: an image determination module 810 configured to determine an anti-distortion camera image and a spherical projection template at the current moment; a texture mapping module 820 configured to determine, for each spherical coordinate point within the spherical projection template, a mapping point texture of the spherical coordinate point within the anti-distortion camera image based on a field of view of a camera; and a video frame recording module 830 configured to perform pixel rendering on the spherical projection template based on the mapping point texture of each spherical coordinate point to obtain the panoramic video frame recorded at the current moment.

In some embodiments of the present application, the texture mapping module 820 may comprise: a mapping point determination unit configured to determine a pixel coordinate of a mapping point of the spherical coordinate point based on the field of view of the camera and an established spherical coordinate mapping relationship; and a mapping point texture determination unit configured to determine the corresponding mapping point texture within the anti-distortion camera image based on the pixel coordinate of the mapping point.

In some embodiments of the present application, the apparatus 800 for panoramic video recording may further comprise a mapping relationship determination module by which the spherical coordinate mapping relationship is determined. Therein, the mapping relationship determination module may be configured to: determine a corresponding pixel coordinate-angle representation relationship based on a first pixel coordinate of a boundary vertex of a field of view in an imaging plane and a second pixel coordinate of any space point of the field of view in the imaging plane, the first pixel coordinate is represented by the field of view of the camera, and the second pixel coordinate is represented by an angle between the space point of field of view and an optical axis of the camera; determine a corresponding spherical coordinate-angle representation relationship based on a spherical coordinate of any space point of the field of view and an angle between the space point of the field of view and the optical axis of the camera; and determine a corresponding spherical coordinate mapping relationship based on the pixel coordinate-angle representation relationship and the spherical coordinate-angle representation relationship.

In some embodiments of the present application, the spherical coordinate mapping relationship comprises a spherical coordinate horizontal mapping relational equation and a spherical coordinate vertical mapping relational equation. The mapping point determination unit may be specifically configured to: substitute a horizontal field of view of the camera and an azimuth angle coordinate of the spherical coordinate point into the spherical coordinate horizontal mapping relational equation to obtain a horizontal pixel coordinate of the mapping point of the spherical coordinate point; and substitute a vertical field of view of the camera, and the azimuth angle coordinate and an elevation angle coordinate of the spherical coordinate point into the spherical coordinate vertical mapping relational equation, to obtain a vertical pixel coordinate of the mapping point of the spherical coordinate point.

In some embodiments of the present application, the image determination module 810 may be specifically configured to: acquire an original camera image at the current moment; and perform anti-distortion processing on the original camera images to obtain a corresponding anti-distortion camera image.

In some embodiments of the present application, the texture mapping module 820 may further comprise: a resolution optimization unit configured to determine an optimal resolution of the spherical projection template based on the field of view of the camera, a camera resolution, and a rendering field of view of the spherical projection template; a coordinate point classification unit configured to determine first-class spherical coordinate points and second-class spherical coordinate points within the spherical projection template based on the optimal resolution; a first texture determination unit configured to determine, for each of the first-class spherical coordinate points, the mapping point texture of the first-class spherical coordinate point within the anti-distortion camera image based on the field of view of the camera; and a second texture determining unit configured to use, for each of the second-class spherical coordinate points, a preset texture as the mapping point texture of the second-class spherical coordinate point; wherein the first-class spherical coordinate points are spherical coordinate points within the field of view range of the camera within the spherical projection template.

In some embodiments of the present application, the coordinate point classification unit may be specifically configured to: determine the spherical coordinate points within the spherical projection template based on the optimal resolution of the spherical projection template; select the spherical coordinate points within the field of view range of the camera from the spherical coordinate points within the spherical projection template as the first-class spherical coordinate points; and use remaining spherical coordinate points other than the first-class spherical coordinate points within the spherical projection template as the second-class spherical coordinate points.

In some embodiments of the present application, the coordinate point classification unit may further be specifically configured to: convert the spherical projection template into a first spherical projection template and a second spherical projection template, a rendering field of view and an image resolution of the first spherical projection template being the field of view of the camera and the camera resolution, respectively, and a rendering field of view and an image resolution of the second spherical projection template being the rendering field of view the spherical projection template and the optimal resolution of the spherical projection template, respectively; use spherical coordinate points within the first spherical projection template as the first-class spherical coordinate points based on the image resolution of the first spherical projection template; and use spherical coordinate points within the second spherical projection template as the second-class spherical coordinate points based on the image resolution of the second spherical projection template.

In some embodiments of the present application, the video frame recording module 830 may be specifically configured to: perform pixel rendering on the first spherical projection template based on the mapping point texture of each of the first-class spherical coordinate points, to obtain a first panoramic candidate frame at the current moment; perform pixel rendering on the second spherical projection template based on the mapping point texture of each of the second-class spherical coordinate points, to obtain a second panoramic candidate frame at the current moment; and merge the first panoramic candidate frame and the second panoramic candidate frame, to obtain the panoramic video frame recorded at the current moment.

In the embodiments of the present application, by real-time recording of a panoramic video, a spherical projection template and an anti-distortion camera image at the current moment are determined first. Based on the field of view of the camera, a mapping point texture of each spherical coordinate point within the spherical projection template is determined within the anti-distortion camera image. Then, based on the mapping point texture of each spherical coordinate point, pixel rendering is performed on the spherical projection template to obtain a panoramic video frame recorded at the current moment, so as to eliminate the camera distortion and the spherical projection distortion within the panoramic video frame, to realize the distortion-free recording of the panoramic video, and to improve the picture quality effect of the panoramic video recording. Moreover, a convenient texture mapping from each spherical coordinate point to the anti-distortion camera image is realized through the field of view of the camera without performing any three-dimensional spatial processing on the spherical coordinate points, which further reduces the frame processing overhead during the panoramic video recording, and thus improves the recording frame rate of the panoramic video, on the basis of guaranteeing the picture quality effect of the panoramic video recording.

It should be understood that the apparatus embodiment and the method embodiment may correspond to each other, and similar descriptions may refer to the method embodiment. In order to avoid repetition, it will not be described herein. Specifically, the apparatus 800 shown in FIG. 8 may perform any of the method embodiments provided in the present application, and the foregoing and other operations and/or functions of the respective modules in the apparatus 800 are respectively designed to realize the corresponding processes in the respective methods of the embodiments of the present application, which will not be repeated herein for the sake of brevity.

The apparatus 800 of the embodiments of the present application is described above in conjunction with the accompanying drawings from the perspective of a functional module. It should be understood that the functional module may be implemented in the form of hardware, in the form of instructions in the form of software, or in the form of a combination of hardware and software modules. Specifically, the respective steps of the method embodiments of the embodiments of the present application may be accomplished by integrated logic circuits of hardware in the processor and/or instructions in the form of software, and the steps of the method disclosed in conjunction with the embodiments of the present application may be directly embodied as being accomplished by execution of a hardware decoding processor or accomplished by execution with a combination of hardware and software modules in the decoding processor. Optionally, the software module may be located in a random memory, a flash memory, a read-only memory, a programmable read-only memory, an electrically erasable programmable memory, a register, and other storage media well established in the art. The storage medium is located in the memory, and the processor reads the information in the memory and completes the steps in the above method embodiments in combination with its hardware.

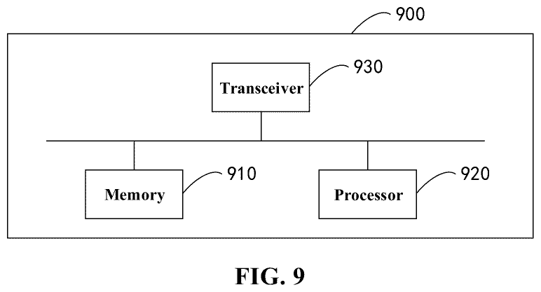

FIG. 9 is a schematic block diagram of an electronic device as illustrated by an embodiment of the present application.

As shown in FIG. 9, the electronic device 900 may comprise: a memory 910 and a processor 920. The memory 910 is used to store a computer program and transmit the program code to the processor 920. In other words, the processor 920 may call and run the computer program from the memory 910 to implement the method in the embodiments of the present application.

For example, the processor 920 may be used to execute the method embodiments described above based on instructions in the computer program.

In some embodiments of the present application, the processor 920 may comprise, but is not limited to: a general-purpose processor, a Digital Signal Processor (DSP), an Application Specific Integrated Circuit (ASIC), a Field Programmable Gate Array (FPGA), or other programmable logic devices, discrete gates, or transistor logic devices, discrete hardware components, and so forth.

In some embodiments of the present application, the memory 910 comprises but is not limited to: volatile memory and/or non-volatile memory. Therein, the non-volatile memory may be Read-Only Memory (ROM), Programmable ROM (PROM), Erasable PROM (EPROM), Electrically EPROM (EEPROM), or flash memory. The volatile memory may be Random Access Memory (RAM), which is used as external high-speed cache. By way of illustrative but not limiting explanation, many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), synch link DRAM (SLDRAM), and Direct Rambus RAM (DR RAM).

In some embodiments of the present application, the computer program may be divided into one or more modules, which are stored in the memory 910 and executed by the processor 920 to perform the method provided by the present application. The one or more modules may be a series of computer program instruction segments capable of performing specific functions, describing the execution process of the computer program in the electronic device.

As shown in FIG. 9, the electronic device may further comprise: a transceiver 930, which may be connected to the processor 920 or the memory 910.

Therein, the processor 920 may control the transceiver 930 to communicate with other devices, specifically, to send or receive information or data to or from other devices. The transceiver 930 may include a transmitter and a receiver. The transceiver 930 may further include an antenna, and the number of antennas may be one or more.

It should be understood that respective components in the electronic device are connected via a bus system, wherein the bus system includes not only a data bus but also a power bus, a control bus, and a status signal bus.

The present application further provides a computer storage medium having stored thereon a computer program that when executed by a computer causes the computer to perform the method of the above method embodiments. Alternatively, the embodiments of the present application further provide a computer program product comprising instructions which when executed by a computer cause the computer to perform the method of the method embodiments described above.

When implemented using software, this may be implemented in whole or in part in the form of a computer program product. The computer program product comprises one or more computer instructions. When the computer instructions are loaded and executed on a computer, all or part of the process or function based on the embodiments of the present application is generated. The computer may be a general-purpose computer, a special-purpose computer, a computer network, or other programmable device. The computer instructions may be stored in a computer-readable storage medium, or transmitted from one computer-readable storage medium to another. For example, the computer instructions may be transmitted from one website site, computer, server, or data center to another website site, computer, server, or data center by wired (e.g., coaxial cable, fiber optics, digital subscriber line (DSL)) or wireless (e.g., infrared, wireless, microwave, etc.) means. The computer-readable storage medium may be any usable medium to which a computer has access or a data storage device such as a server, data center, etc. that contains one or more usable media integrated. The usable medium may be a magnetic medium (e.g., a floppy disk, a hard disk, a magnetic tape), an optical medium (e.g., a digital video disc (DVD)), or a semiconductor medium (e.g., a solid state disk (SSD)), and the like.

Those of ordinary skill in the art would appreciate that the modules and algorithmic steps described in conjunction with the various examples of the embodiments disclosed herein are capable of being implemented in electronic hardware, or a combination of computer software and electronic hardware. Whether these functions are performed in hardware or software depends on the particular application and design constraints of the technical solution. The skilled professional may use different methods to implement the described functions for each particular application, but such implementations should not be considered outside the scope of the present application.

In several embodiments provided by the present application, it should be understood that the disclosed systems, apparatus, and methods may be implemented in other ways. For example, the apparatus embodiments described above are merely illustrative, and for example, the division of modules is only a logical division of functions, and other division methods may be used in actual implementation, such as combining multiple modules or components or integrating them into another system, or some features may be ignored or not executed. At another point, the mutual coupling or direct coupling or communication connection shown or discussed may be an indirect coupling or communication connection through some interface, apparatus or module, which may be electrical, mechanical or otherwise.

The modules described as separate components may or may not be physically separate, and the components shown as modules may or may not be physical modules, i.e., they may be located in one place or may also be distributed over a plurality of network units. Some or all of these modules may be selected to fulfill the purpose of solution of the embodiment according to actual needs. For example, the various functional modules in various embodiments of the present application may be integrated in a single processing module, or each module may be physically present separately, or two or more modules may be integrated in a single module.

The above provided are only specific embodiments of the present application, but the protection scope of the present application is not limited thereto. Any changes or substitutions that can be easily conceived by those skilled in the art within the technical scope disclosed in the present application should be covered within the protection scope of the present application. Therefore, the protection scope of the present application should be subject to the protection scope of the claims.

I/we claim:

1. A method for panoramic video recording, comprising:
determining a spherical projection template and an anti-distortion camera image at a current moment;
determining, for each spherical coordinate point within the spherical projection template, a mapping point texture of the spherical coordinate point within the anti-distortion camera image based on a field of view of a camera; and
performing pixel rendering on the spherical projection template based on the mapping point texture of each spherical coordinate point, to obtain a panoramic video frame recorded at the current moment.

2. The method according to claim 1, wherein the determining the mapping point texture of the spherical coordinate point within the anti-distortion camera image based on the field of view of the camera comprises:
determining a pixel coordinate of a mapping point of the spherical coordinate point based on the field of view of the camera and an established spherical coordinate mapping relationship; and
determining a corresponding mapping point texture within the anti-distortion camera image based on the pixel coordinate of the mapping point.

3. The method according to claim 2, wherein the spherical coordinate mapping relationship is determined by:
determining a corresponding pixel coordinate-angle representation relationship based on a first pixel coordinate of a boundary vertex of a field of view in an imaging plane and a second pixel coordinate of any space point of the field of view in the imaging plane, the first pixel coordinate being represented by the field of view of the camera, and the second pixel coordinate being represented by an angle between the space point of field of view and an optical axis of the camera;
determining a corresponding spherical coordinate-angle representation relationship based on a spherical coordinate of any space point of the field of view and an angle between the space point of the field of view and the optical axis of the camera; and
determining a corresponding spherical coordinate mapping relationship based on the pixel coordinate-angle representation relationship and the spherical coordinate-angle representation relationship.

4. The method according to claim 2, wherein the spherical coordinate mapping relationship comprises a spherical coordinate horizontal mapping relational equation and a spherical coordinate vertical mapping relational equation, and the determining the pixel coordinate of the mapping point of the spherical coordinate point based on the field of view of the camera and the established spherical coordinate mapping relationship comprises:
substituting a horizontal field of view of the camera and an azimuth angle coordinate of the spherical coordinate point into the spherical coordinate horizontal mapping relational equation, to obtain a horizontal pixel coordinate of the mapping point of the spherical coordinate point; and
substituting a vertical field of view of the camera, and the azimuth angle coordinate and an elevation angle coordinate of the spherical coordinate point into the spherical coordinate vertical mapping relational equation, to obtain a vertical pixel coordinate of the mapping point of the spherical coordinate point.

5. The method according to claim 1, wherein the determining the anti-distortion camera image at the current moment comprises:
acquiring an original camera image at the current moment; and
performing anti-distortion processing on the original camera image to obtain a corresponding anti-distortion camera image.

6. The method according to claim 1, wherein the determining, for each spherical coordinate point within the spherical projection template, the mapping point texture of the spherical coordinate point within the anti-distortion camera image based on the field of view of the camera comprises:
determining an optimal resolution of the spherical projection template based on the field of view of the camera, a camera resolution, and a rendering field of view of the spherical projection template;
determining first-class spherical coordinate points and second-class spherical coordinate points within the spherical projection template based on the optimal resolution;
determining, for each of the first-class spherical coordinate points, the mapping point texture of the first-class spherical coordinate point within the anti-distortion camera image based on the field of view of the camera; and
using, for each of the second-class spherical coordinate points, a preset texture as the mapping point texture of the second-class spherical coordinate point;
wherein the first-class spherical coordinate points are spherical coordinate points within the field of view range of the camera within the spherical projection template.

7. The method according to claim 6, wherein the determining the first-class spherical coordinate points and the second-class spherical coordinate points within the spherical projection template based on the optimal resolution comprises:
determining the spherical coordinate points within the spherical projection template based on the optimal resolution of the spherical projection template;
selecting the spherical coordinate points within the field of view range of the camera from the spherical coordinate points within the spherical projection template as the first-class spherical coordinate points; and
using remaining spherical coordinate points other than the first-class spherical coordinate points within the spherical projection template as the second-class spherical coordinate points.

8. The method according to claim 6, wherein the determining the first-class spherical coordinate points and the second-class spherical coordinate points within the spherical projection template based on the optimal resolution comprises:
converting the spherical projection template into a first spherical projection template and a second spherical projection template, a rendering field of view and an image resolution of the first spherical projection template being the field of view of the camera and the camera resolution, respectively, and a rendering field of view and an image resolution of the second spherical projection template being the rendering field of view of the spherical projection template and the optimal resolution of the spherical projection template, respectively;
using spherical coordinate points within the first spherical projection template as the first-class spherical coordinate points based on the image resolution of the first spherical projection template; and
using spherical coordinate points within the second spherical projection template as the second-class spherical coordinate points based on the image resolution of the second spherical projection template.

9. The method according to claim 8, wherein the performing pixel rendering on the spherical projection template based on the mapping point texture of each spherical coordinate point to obtain the panoramic video frame recorded at the current moment comprises:
performing pixel rendering on the first spherical projection template based on the mapping point texture of each of the first-class spherical coordinate points, to obtain a first panoramic candidate frame at the current moment;
performing pixel rendering on the second spherical projection template based on the mapping point texture of each of the second-class spherical coordinate points, to obtain a second panoramic candidate frame at the current moment; and
merging the first panoramic candidate frame and the second panoramic candidate frame, to obtain the panoramic video frame recorded at the current moment.

10. An electronic device comprising:
a processor and a memory, wherein the memory is configured to store a computer program, and the processor is configured to invoke and run the computer program stored in the memory to:
determine a spherical projection template and an anti-distortion camera image at a current moment;
determine, for each spherical coordinate point within the spherical projection template, a mapping point texture of the spherical coordinate point within the anti-distortion camera image based on a field of view of a camera; and
perform pixel rendering on the spherical projection template based on the mapping point texture of each spherical coordinate point, to obtain a panoramic video frame recorded at the current moment.

11. The electronic device according to claim 10, wherein the computer program causing the processor to determine the mapping point texture of the spherical coordinate point within the anti-distortion camera image based on the field of view of the camera further causes the processor to:
determine a pixel coordinate of a mapping point of the spherical coordinate point based on the field of view of the camera and an established spherical coordinate mapping relationship; and
determine a corresponding mapping point texture within the anti-distortion camera image based on the pixel coordinate of the mapping point.

12. The electronic device according to claim 11, wherein the spherical coordinate mapping relationship is determined by causing the processor to:
determine a corresponding pixel coordinate-angle representation relationship based on a first pixel coordinate of a boundary vertex of a field of view in an imaging plane and a second pixel coordinate of any space point of the field of view in the imaging plane, the first pixel coordinate being represented by the field of view of the camera, and the second pixel coordinate being represented by an angle between the space point of field of view and an optical axis of the camera;
determine a corresponding spherical coordinate-angle representation relationship based on a spherical coordinate of any space point of the field of view and an angle between the space point of the field of view and the optical axis of the camera; and
determine a corresponding spherical coordinate mapping relationship based on the pixel coordinate-angle representation relationship and the spherical coordinate-angle representation relationship.

13. The electronic device according to claim 11, wherein the spherical coordinate mapping relationship comprises a spherical coordinate horizontal mapping relational equation and a spherical coordinate vertical mapping relational equation, and the computer program causing the processor to determine the pixel coordinate of the mapping point of the spherical coordinate point based on the field of view of the camera and the established spherical coordinate mapping relationship further causes the processor to:
substitute a horizontal field of view of the camera and an azimuth angle coordinate of the spherical coordinate point into the spherical coordinate horizontal mapping relational equation, to obtain a horizontal pixel coordinate of the mapping point of the spherical coordinate point; and
substitute a vertical field of view of the camera, and the azimuth angle coordinate and an elevation angle coordinate of the spherical coordinate point into the spherical coordinate vertical mapping relational equation, to obtain a vertical pixel coordinate of the mapping point of the spherical coordinate point.

14. The electronic device according to claim 10, wherein the computer program causing the processor to determine the anti-distortion camera image at the current moment further causes the processor to:
acquire an original camera image at the current moment; and
perform anti-distortion processing on the original camera image to obtain a corresponding anti-distortion camera image.

15. The electronic device according to claim 10, wherein the computer program causing the processor to determine, for each spherical coordinate point within the spherical projection template, the mapping point texture of the spherical coordinate point within the anti-distortion camera image based on the field of view of the camera further causes the processor to:
determine an optimal resolution of the spherical projection template based on the field of view of the camera, a camera resolution, and a rendering field of view of the spherical projection template;
determine first-class spherical coordinate points and second-class spherical coordinate points within the spherical projection template based on the optimal resolution;
determine, for each of the first-class spherical coordinate points, the mapping point texture of the first-class spherical coordinate point within the anti-distortion camera image based on the field of view of the camera; and
use, for each of the second-class spherical coordinate points, a preset texture as the mapping point texture of the second-class spherical coordinate point;
wherein the first-class spherical coordinate points are spherical coordinate points within the field of view range of the camera within the spherical projection template.

16. The electronic device according to claim 15, wherein the computer program causing the processor to determine the first-class spherical coordinate points and the second-class spherical coordinate points within the spherical projection template based on the optimal resolution further causes the processor to:
determine the spherical coordinate points within the spherical projection template based on the optimal resolution of the spherical projection template;
select the spherical coordinate points within the field of view range of the camera from the spherical coordinate points within the spherical projection template as the first-class spherical coordinate points; and
use remaining spherical coordinate points other than the first-class spherical coordinate points within the spherical projection template as the second-class spherical coordinate points.

17. The electronic device according to claim 15, wherein the computer program causing the processor to determine the first-class spherical coordinate points and the second-class spherical coordinate points within the spherical projection template based on the optimal resolution further causes the processor to:
convert the spherical projection template into a first spherical projection template and a second spherical projection template, a rendering field of view and an image resolution of the first spherical projection template being the field of view of the camera and the camera resolution, respectively, and a rendering field of view and an image resolution of the second spherical projection template being the rendering field of view of the spherical projection template and the optimal resolution of the spherical projection template, respectively;
use spherical coordinate points within the first spherical projection template as the first-class spherical coordinate points based on the image resolution of the first spherical projection template; and
use spherical coordinate points within the second spherical projection template as the second-class spherical coordinate points based on the image resolution of the second spherical projection template.

18. The method according to claim 17, wherein the computer program causing the processor to perform pixel rendering on the spherical projection template based on the mapping point texture of each spherical coordinate point to obtain the panoramic video frame recorded at the current moment further causes the processor to:
perform pixel rendering on the first spherical projection template based on the mapping point texture of each of the first-class spherical coordinate points, to obtain a first panoramic candidate frame at the current moment;
perform pixel rendering on the second spherical projection template based on the mapping point texture of each of the second-class spherical coordinate points, to obtain a second panoramic candidate frame at the current moment; and
merge the first panoramic candidate frame and the second panoramic candidate frame, to obtain the panoramic video frame recorded at the current moment.

19. A non-transitory computer-readable storage medium storing a computer program, the computer program causing a computer to:
determine a spherical projection template and an anti-distortion camera image at a current moment;
determine, for each spherical coordinate point within the spherical projection template, a mapping point texture of the spherical coordinate point within the anti-distortion camera image based on a field of view of a camera; and
perform pixel rendering on the spherical projection template based on the mapping point texture of each spherical coordinate point, to obtain a panoramic video frame recorded at the current moment.

20. The non-transitory computer-readable storage medium according to claim 19, wherein the computer program causing the computer to determine the mapping point texture of the spherical coordinate point within the anti-distortion camera image based on the field of view of the camera further causes the computer to:
determine a pixel coordinate of a mapping point of the spherical coordinate point based on the field of view of the camera and an established spherical coordinate mapping relationship; and
determine a corresponding mapping point texture within the anti-distortion camera image based on the pixel coordinate of the mapping point.
